(19) United States
(12) Patent Application Publication
(10) Pub. No.: US 2009/0070572 A1
(43) Pub. Date: Mar. 12, 2009

(54) METHOD AND APPARATUS FOR PORTABLE COMPUTING ENVIRONMENT

(76) Inventors: Mark SHAHAF, Rehovot (IL); Moshe LEVINSON, Lapid (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(21) Appl. No.: 11/853,060

(22) Filed: Sep. 11, 2007

(51) Int. Cl. G06F 15/177

(52) U.S. Cl. 713/1

(57) ABSTRACT

A method and storage device for enabling a user to carry his or her computing environment with him, including an operating system, GUI preferences, applications, or data. Thus, a user can attach the storage device to a host computer and work on the host computer with its peripherals, while applying the parameters such as operating system and GUI preferences as stored on the device.

### BACKGROUND

1. Technical Field

The present disclosure relates to portable computing devices in general, and to a portable computing environment in particular.

2. Discussion of the Related Art

In modern environments, people often have computing needs when outside their homes or offices. Such needs may include viewing stored information, such as text documents, maps, pictures, bills, tables or other documents; receiving new information, such as receiving new e-mails, downloading information from web pages or the like; also performing computing activities, such as composing documents, updating tables, performing calculations and others; and particularly using gaming applications, since it is typical for players to play the game he downloaded or purchased on a friend's computer.

For all these needs, most people would prefer having their own customized system, which includes their favorite operating system, customizations such as language, fonts, favorite websites, and others.

Carrying a laptop for the abovementioned activities suffers from a number of drawbacks. First, the weight and volume of a laptop computer is not negligible. Carrying a laptop around, together with a power supply and cable requires physical storage such as at least a large enough padded compartment in a carried bag or case. Second, many people find it uncomfortable to work for long periods of time using a laptop computer, mainly due to the relatively small display and keyboard, and built-in pointing device. However, carrying around even just a mouse with the laptop is another burden. In addition, laptops suffer from inflexible hardware configuration. Meaning that it is hard or impossible to replace a graphic card in a laptop computer or add additional disk to the laptop computer and thus enhance its capabilities.

Another family of solutions comprises handheld devices, such as a personal digital assistant (PDA). However, a proper working environment requires a reasonably large screen and keyboard along with a comfortable mouse. The ability to accurately view and manipulate documents with more than the minimum amount of data or communicate with emails longer than a few lines cannot be realized on today's palm sized devices.

Yet another unsatisfactory solution is a portable storage device, such as a disk-on-key, which is used for carrying documents, applications, and other information and using the, with constant or occasional computing platforms. The small dimensions of the device enable easy carrying and does not present special care requirements. However, when the device is connected to a computing platform, the data and applications can be used, but the user is limited to using the is settings and customizations of the hosting computing platform, including operating system, language, and other parameters. The user generally does not have the computing environment he or she prefers and feels most comfortable and efficient with. If a person wishes to accommodate the available system to his or her preference, this may be a long process which may not be worthwhile for a short period of time. In addition, it is unlikely that a temporary guest user will be allowed to change things such as an operating system or a system parameter.

There is thus a need in the art for a method and device for enabling a person to easily carry his or her data and applications, as well as their preferred environment, such as an operating system, Graphic User Interface (GUI), and preferred settings. In addition, the methods and apparatuses should support the case of a person often using a particular computing platform as a host. In this case, it is desirable to make the utilizing process faster and not to have to repeat the process every time. Moreover, it is desirable to screen out the disks or other storage devices associated with the host computer from a guest user. This is required in order to protect the storage devices from data which might be hazardous, such as viruses or Trojan horses stored by the guest, and on the other hand to provide security for the guest, by ensuring that no information is left behind when he leaves the host computing platform.

### SUMMARY

The disclosed method and apparatus enable a user to carry his or her favorite computing platform on a portable device, and to apply it while using available computing platform. The characteristics of the computing platform, including for example device drivers and communication configuration are backed up, and those of them which are active, i.e. relate to connected devices are copied to the portable device. The computing platform is then started form the portable device, thus enabling the user to apply his favorite parameters, including for example operating system, towards using a foreign computer. Environments of multiple computers can be stored on the portable device, thus enabling the user to use the computers without having to first backup and copy items.

In accordance with the disclosure, there is thus provided a method for applying one or more usage parameter stored on a storage device, to a session in which a user is using a host computing platform, the method comprising the steps of: backing up one or more first entities associated with one or more aspects of the host computing platform, to a location; storing one or more second entities associated with the aspects on the storage device; and restarting the host computing platform from the storage device introduced to the host computing platform using the second entities and applying the usage parameters to the session. Within the method, the step of backing up the first entities optionally comprises the steps of: copying the first entities from a second storage device associated with the computing platform; and determining the second entities associated with the aspects from the first entity. Within the method, the aspects may relate to a device of the host computing platform. Within the method, the first entities or the second entities are optionally one or more device drivers or items related to communication configuration. Any of the second entities is optionally any of the first entities. The method optionally comprises the step of updating the storage device with one or more configuration parameters associated with the second entities. The configuration parameters can be one or more registry entries. The method can further comprise the step of copying the first entities from the location to the storage device. The method can further comprise the step of receiving the second entities. The second entities are optionally downloaded from a web site. The location is optionally a location on the storage device. Within the method, determining the second entities optionally relates to one or more registry entries. The method optionally comprises the step of modifying one or more configuration parameters on the storage device. The storage device is optionally a flash memory device or a phone. The usage parameters are optionally selected from the group consisting of: an operating system; a registry entry; a graphic user interface parameter; a web site list; and a desktop description. The method can further comprise the steps of: copying one or more content items from a source computing platform to the storage device; copying an application for booting a computing platform from an external device to the storage device; and copying a backup application to the storage device. Within the method, any of the content items can be selected from the group consisting of: an operating system; a registry is entry; a graphic user interface parameter; a web site list; a desktop description; an application; and a data file. The method can further comprise the step of disabling a user using the host computing platform from accessing one or more storage devices associated with the computing platform. The method optionally comprises the steps of: determining whether the storage device was already connected to host computing platform; and restoring the second entities on the storage device.

Another aspect of the disclosed invention relates to a storage device for applying one or more usage parameters to a session in which a user is using a host computing platform, the storage device storing: an application for storing one or more first entities associated with one or more aspects of the host computing platform on the storage device; and an application for booting the host computing platform from the storage device using one or more second entities and applying the usage parameters to the session. The storage device can further store one or more items selected from the group consisting of: an operating system; a usage parameter; a device driver; a registry entry; an application; and a data file. The application for storing the first entities can further comprise an application for determining the second entities from the first entities. The application for determining the second entities optionally relates to one or more registry entries of the host computing platform. Any of the first entities or the second entities is optionally a device driver of the host computing platform or an item related to communication configuration. The storage device can further store two or more entities, each of the two or more entities related to a different computing platform. The storage device optionally further comprises an application for receiving one or more second entities associated with the one or more aspects of the host computing platform. Receiving the second entities is optionally performed by downloading the second entities. Within the storage device, the aspects of the computing platform optionally comprise one or more registry entries. The storage device can further store host computing platforms association data, or an application for disabling a user using the host computing platform from accessing one or more storage devices associated with the computing platform. The storage device is optionally a phone or a flash memory device.

### BRIEF DESCRIPTION OF THE DRAWINGS

Attention is now directed to the drawing figures, where corresponding or like numerals or characters indicate corresponding or like components. In the drawings:

FIG. 1 is a schematic illustration of a preferred embodiment of the disclosed device;

FIG. 2A is a flowchart of the main steps in a preferred embodiment of a method for preparing a device in accordance with the disclosure;

FIG. 2B is a flowchart of the main steps in a preferred embodiment of a method for using a device prepared according to the method presented in FIG. 2A; and

FIG. 3 is a schematic illustration of the contents of the device after being prepared according to the method detailed in FIG. 2A.

### DETAILED DESCRIPTION

The disclosed subject matter provides a novel method and apparatus for enabling a person to carry his or her computing environment, on a portable storage device, such as a disk on key or a mobile phone. When carrying the computing environment, a user can use any computing platform with its peripheral devices, such as display, keyboard, mouse and others, and immediately have available his data, applications, favorite operating system, settings and parameters, such as language, and Graphic User Interface (GUI) configuration such as look and feel variables. Thus, a user will have his own environment no matter which computing platform he or she is using, without being required to accommodate the working environment to his needs, or make adjustments in order to be able to use the peripheral devices of the computing platform.

With the increasing memory volumes available on mobile devices in general and mobile phones in particular, a user carrying such device can connect or otherwise introduce the device to any hosting computing platform, via any connector or connecting protocol currently existing or that will be developed in the future, including any wired or wireless protocol, and enjoy his favorite computing environment while using the peripheral devices of the host machine, and while avoiding any possible damage or privacy violation to the host machine.

In a preferred embodiment, any non-removable storage devices associated with the hosting computing platform will be screened out from the user utilizing the computing platform through the device of the disclosure. Screening out the storage devices will enable to keep them unchanged, and thus protect them from the host's point of view, and to avoid leaving information behind, from the user's point of view.

The disclosed method starts when the external storage device, such as a Universal Serial Bus (USB) device, a cellular phone or any other compatible device is inserted, attached or otherwise introduced to a host computing platform. Then, an application stored on the device is activated. The application backs up, i.e. stores in a dedicated location the environment, i.e. one or more aspects associated with the configuration of the computing platform, including for example registry entries and active drivers of the computing platform The configuration is then copied to the device, and the computing platform is restarted from the device. Thus, after booting the computing platform from the device, the user has available and applies his regular environment, including usage parameters such as the operating system, registry entries, GUI parameters and preferences, web site lists such as favorites, a description of the desktop, data or applications, while being able to use via the drivers or other aspects the available peripherals of the host computing platform, including the input output devices such as display, keyboard, mouse, joystick, speakers, microphone or others. The storage devices associated with the computing platform, such as disks, are preferably hidden by modifying running BIOS. Access to fixed storage devices is usually performed through the computer's motherboard. Motherboard manufacturers support accessing the storage devices via functions stored in the BIOS. When the operating system starts, it loads the corresponding driver which is responsible for communicating with the motherboard. Functions in this driver can be overwritten, so that the storage device will not be accessible.

The user then works on the computing platform, and can fully utilize the environment, while enjoying the operating system and configuration he or she is used to, and having all required data and applications.

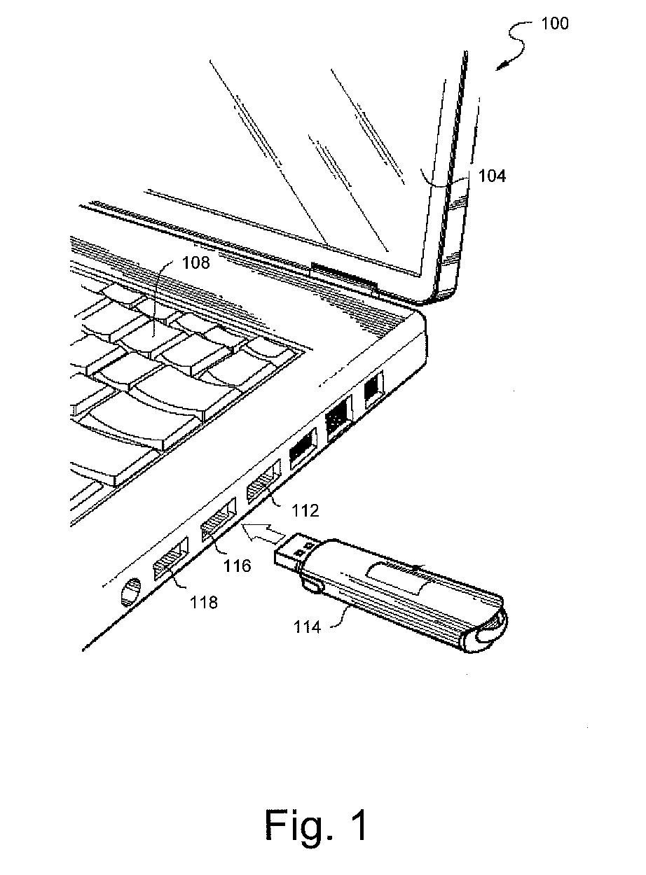

Referring now to FIG. 1, showing a preferred embodiment of the disclosed device. Device 114 is preferably a portable storage device, storing thereon computer applications for implementing the disclosed methods. The applications preferably comprise a backup/restore application and a boot-from-device application. Device 114 can be any portable storage device, such as a USB flash drive manufactured by SanDisk (www.sandisk.com) or any other non-volatile storage device. The device must have one or more common interfaces such as USB, serial, wireless, Ethernet interface as modern BIOS allows booting via Ethernet, or any other currently known interface or any appropriate interface that will be developed in the future, in order to be able to connect to as many host computers as possible. Other embodiments may include a cellular phone, a Personal Digital Assistant (PDA) or other portable devices comprising storage. The host computer, generally referenced 100, is any computing platform equipped with input or output devices such as display 104 and keyboard 108, and with one or more interfaces compatible with the interfaces of device 114, such as ports 112, 116 or 118. Computer 100 can be a laptop computer, a desktop computer, a terminal or any other computing platform. The backup application and the boot-from-device application are preferably implemented as software applications, comprising one or more collections of computer instructions, such as executables, scripts, modules, dynamic libraries, static libraries or the like. The applications can be developed in any programming language, such as C, C++, C#, Perl, Java, or others, and under any development environment, such as .NET, J2EE, or others. The applications can alternatively be third party products.

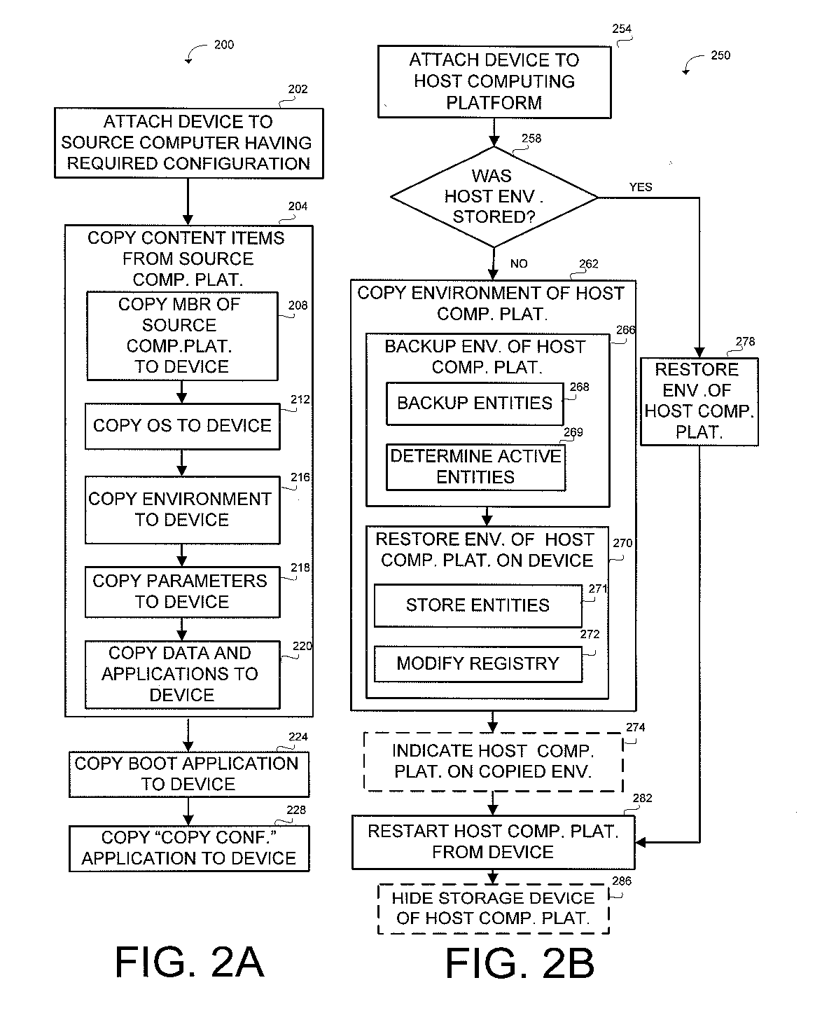

Referring now to FIG. 2A, showing a flowchart of the main steps in a preferred embodiment of a method for preparing a device, so the device can be used with multiple host computers. The method, generally referenced 200, is performed once, after which the device can be used an unlimited number of times with any number of host computers. The method of FIG. 2A need re-visiting only if one or more components of the configuration preferred by the user changes, such as the operating system, GUI preferences, or others. The method starts on step 202 by attaching the device, such as device 114 of FIG. 1 to a source computing platform, preferably the user's home or office computer, having the required configuration, i.e. the basic configuration which the user wishes to employ on one-time, occasional, or regularly visited host computers.

On step 204 the relevant content items of the host computer are copied from the source computing platform to the device. Step 204 comprises sub-step 208 in which the master boot record is created on the master device by using a standard utility such as fdisk, followed by sub-step 212 in which the operating system itself is copied from the source computing platform to the device. On step 216 the environment, of the source computing platform are copied to the device, as detailed in association with step 262 of FIG. 2B below. The environment includes specific drivers and configurations thereof, as indicated for example by registry entries in Windows XP and Windows Vista of Microsoft of Redmond, Wash. On step 218, the user's usage parameters, such as language, GUI preferences, favorite web site list, desktop description and others are copied to the device. In some embodiments, step 220 can be performed as part of step 212 of copying the operating system. On step 220 data and applications needed for the user are copied to the device. In Windows-based operating systems, copying may require modifications to Windows Registry to reflect possible change in drive letters settings. Step 220 may be performed occasionally even when there is no requirement to adjust the device to a new configuration, for the purpose of updating data and applications between the device and one or more computing platforms, as is commonly done with portable storage devices. On step 224, a boot application, i.e. an application that lets a computing platform boot from an external device, such as an external USB device is copied to the device. On step 228, A configuration copying application is copied to the device. The application is preferably the same application used to copy the configuration of the source computing platform to the device. Steps 224 and 228 can be performed any time, prior to, during, or after copying the source on step 204, and in any relative order. Once method 200 is completed, the device can be used with any computing platform, and enable the user to work on his data and applications under his favorite operating system, configurations, GUI and other preferences. The content copied in steps 208, 212, 216, 218, 220, 224 and 228 can be copied from multiple source computing platforms and are not limited to copying all contents from a single source computing platform. It will be apparent that in order to copy items from different source computing platforms, the device needs to be detached from the a computing platform and attached to a second one, or receive information from other platforms via a communication channel between the source computing platform it is attached to and a second computing platform. Alternatively, if the device will be the boot device for all platforms a person will use, then instead of step 204 and all its substeps, the user can just install the operating system and all applications from scratch on the device therefore and avoid all copying.

Referring now to FIG. 2B, showing a flowchart of the main steps in a preferred embodiment of a method for using device prepared according to the method presented in FIG. 2A with a host computer. The method, generally referenced 250, is performed any time a user wishes to work on a host computer and use the operating system and configurations stored on the device by the method of FIG. 2A above. On step 254, the device is attached, inserted or is otherwise brought in contact with the host computing platform, for example by inserting device 114 of FIG. 1 to a USB port on the host computer. On step 258, it is determined whether the host environment was already stored on the device in a previous usage. The determination is preferably done by checking the device for indications related to storage of information related to the specific platform, or an indication related to a CPU ID stored on the device.

If the host environment was not previously stored on the device, on step 262 the environment is stored on the device. Step 262 comprises sub-step 266 in which the environment of the host computer is backed up to a predetermined location. The environment includes entities related to aspects of the computing platform, such as device drivers of devices including hardware devices associated with the platform, such as display, keyboard, mouse, joystick, printer, scanner, microphone, speakers, or any other device. The entities may further include configuration items related to communication, including for example IP address of the host computer, DNS, default gateway and others. In Windows XP and Windows Vista, the devices are accessed through the registry, and the relevant registry entries are also backed up. In a preferred embodiment, step 266 comprises substep 268 in which one or more entities such as device drivers are copied, and step 269 in which active device drivers are determined, for example by examining the registry of the computing platform. For example, a computing platform may have two drivers for two different mice, and on step 269 only the device driver associated with the currently connected mouse will be determined. Step 266 can be performed by a third party tool, such as Driver Magician developed by GoldSolution (www.drivermagician.com). On sub-step 270 of step 262, the backed up environment is stored on the device. On step 271, the entities such as device drivers are stored on the device. If the operating system of the host computer is the same as the operating system installed on the device, the device drivers determined on step 269 are copied to the device. If the operating system of the host computer is not the same as the operating system installed on the device, then different drivers may be required for the same devices. Such drivers can be received or loaded downloaded upon demand from a source such as a disk, or relevant web site, such as but not limited to a web site maintained by a supplier of the disclosed device.

On step 272, it is determined whether the paths of the folders as appear in the registry are consistent with the paths on the device. If not, either the location of one or more drivers is adjusted, or a configuration parameter such as one or more registry entries are changed.

On optional step 274, the identity of the host computer, for example its serial number, is associated with the copied backup, so if the same host computing platform is to be used with the same device again in the future, steps 266 and 270 do not have to be repeated, but rather step 278 takes place, in which the environment of the host computer is restored to the correct location on the device or the registry entries are updated. Step 274 can be activated subject to the user being presented with a question whether he intends to return to the same host computer in the future and answers positively.

When the operating system stored or installed on the device is not the same one as the operating system of the host computer, for example, Windows XP vs. Vista operating systems, the drivers may not be compatible. In such cases, environment backup step 266 may be replaced by a first application that merely lists the required drivers, according to the available hardware components, and a second application that fetches the versions of the relevant drivers which are compatible with the device.

On step 282 the host computer is restarted from the device introduced to the computing platform, which has the effect of applying the user's usage parameters to a session of working with the host computing platform and using the backed up. Thus, the user usage parameters such as operating system, configuration and others are applied to a session of working with the host computing platform and its peripherals. The user can then conveniently use his own data and applications as stored on the device and under the same parameters he is used to, while using the environment of the host computer, including aspects such as input and output devices. Restarting the computing platform from an external device is enabled by any modern motherboard. Alternatively, booting a computer from an external device can be done by third party products, such as Wizpy TurboLinux manufactured by Wizpy (www.wizpy.com).

On optional step 286, the storage devices of the host computer, for example associated disks are concealed from the user using the host computer via the device. Concealing the disks is done in order to protect the disk's integrity from undesired content such as viruses, and to protect the user of the device from security holes. Thus, the user's data is stored solely on the device without affecting the content of a storage device associated with the host computing platform. Hiding the disks or other storage devices associated with the host computing platform can be done by modifying the running BIOS so that local hard drives are not available to the operating system.

Step 262 and its sub-steps 266, 270, 274, as well as step 282 and step 286 are performed by the host computer, by executing one or more applications stored on the user's device. Thus, the applications are available to the host computer once the device is attached to the host computer,

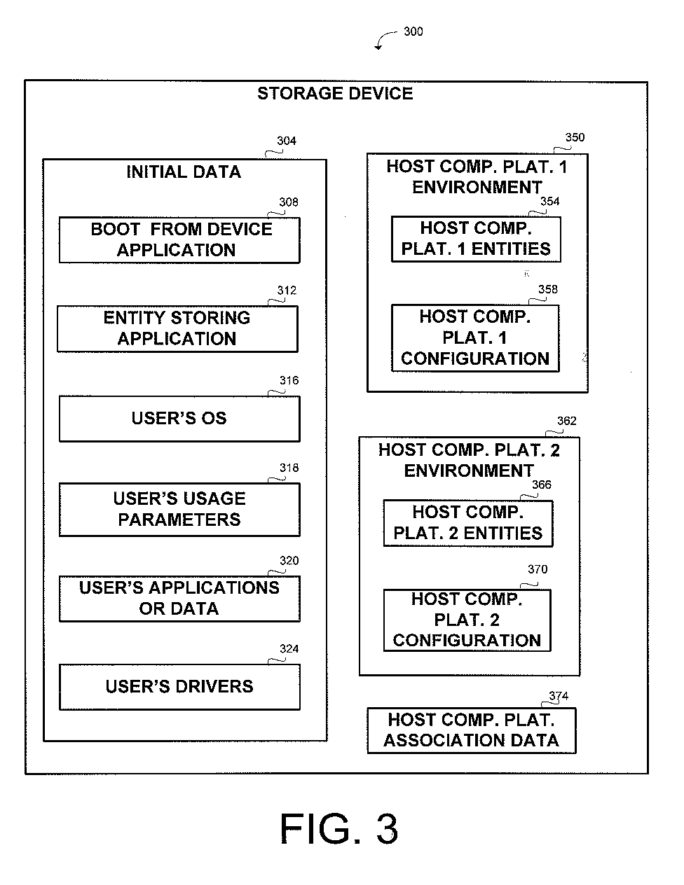

Reference is now made to FIG. 3, showing a schematic illustration of the contents of the device after being prepared according to the method detailed in association with FIG. 2A above. The storage device, generally referenced 300 stores data of two main categories. The first type relates to data stored or installed on the device during the preparation step, as discussed in association with FIG. 2A above. The second type relates to data specific to one or more particular host computers, and is stored on the device prior to being used. Initial data 304 comprises data of the first type, and preferably includes an application 308 for booting from the device. Application 308 is stored on the device during preparation, and is executed by the host computing platform during usage as detailed in association with step 282 of FIG. 2B above to reboot the computing platform from the device. Initial data 304 further comprises application 312 for storing entities associated with the environment of the host computer. Application 312 when invoked backs up and stores the entities, preferably including the device drivers and the communication configuration, preferably the registry entries of the host computer, and copies the environment to the device, as detailed in association with step 266 and step 270 of FIG. 2B above. Application 312 preferably comprises a component for determining the active entities within the system, for example by examining the registry. Initial data 316 further comprises the user's preferred operating system 316, as copied or installed onto the device, the user's preferred usage parameters, such as language, web site lists, GUI preferences, and others. The device further stores the user's required applications or data 320, including for example the user's favorite web sites, GUI configuration, and others. Initial data 304 optionally comprises also the environment, i.e. the drivers and registry entries of the user's source computing platform, such as his or her home or office computer, the configuration of which the user wishes to use everywhere.

The second type of information comprises information copied to device 300 when he or she wishes to use the device when using another computer. The storage then comprises the environment of computing platform 1 (350), the environment of computing platform 2 (362) and similarly for additional host computing platforms. Host computing platform 1 environment (350) preferably comprises computing platform 1 drivers (354) and a subset of computing platform 1 registry (358), containing the entries relevant for the device drivers and communication configuration of computing platform 1. Similarly computing platform 2 environment preferably comprises computing platform 2 drivers and communication configuration (366) and a subset of computing platform 2 registry (362), containing the entries relevant for the device drivers and communication configuration of computing platform 2. The device preferably comprises also host computing platform association data 374, which may be a table or any other data structure or application required for associating a computing platform, identified for example by a serial ID with an area of the device comprising information related to the environment of the particular computing platform. Data 374 optionally saves time in subsequent preparations of the device for working with a particular host computing platform, after the device was already used once or more with the particular host computing platform.

The disclosed method and apparatus enable a user to carry a device storing the user's data and applications, as well as his or her favorite operating system, parameters, configurations and, favorites. The device can then be used to enable the user to use any computing platform while applying his preferences, operating system, or other usage parameters. The device can thus be used for dynamically adjusting an operating system installed on a device to a changing hardware environment or a changing communication environment. Further describes is a method for keeping multiple hardware configurations and communication configurations and for automatically activating the correct configurations based on machine identification.

A person can further purchase such device with pre-installed operating system and favorites, and use the device with any host machine, and thus enjoy computing capabilities without carrying or even purchasing a laptop computer. Using a host computer is done without having to login to the host machine, without violating the privacy or otherwise risking the user of the device or of a user of the host computer. The device and methods can be useful for all persons requiring computing capabilities from random or known platforms, such as students who need requiring computing capabilities both at home and in school, people traveling without a laptop computer, game players who require computing capabilities and graphics higher than those offered by laptops, or the like.

The data comprised on the device is preferably protected with any desired protection method, so that if the device is lost or stolen its contents are not exposed to illegitimate users. The protection can use any password, program or action, whether known to a user, stored on the device or stored on any other location.

In cases wherein one or more applications are protected for example by a code installed on a particular computer, a complementary protection mechanism should be used, for example providing a code or a license for a specific storage device rather than to a specific computer. A user can then legally use the particular application when switching between computers.

A person skilled in the art will appreciate that the disclosed method and apparatus may be changed, for example by changing, omitting or adding steps or stored components, and are still within the true scope and spirit of the current disclosure.

While preferred embodiments of the disclosed subject matter have been described, so as to enable one of skill in the art to practice the disclosed subject matter. The preceding description is intended to be exemplary only and not be used to limit the scope of the disclosure to what has been particularly shown and described hereinabove. The scope of the disclosure should be determined by reference to the following claims.

What is claimed is:

1. A method for applying an at least one usage parameter stored on a storage device, to a session in which a user is using a host computing platform, the method comprising the steps of:
backing up an at least one first entity associated with an at least one aspect of the host computing platform, to a location;
storing an at least one second entity associated with the at least one aspect on the storage device; and
restarting the host computing platform from the storage device introduced to the host computing platform using the at least one second entity and applying the at least one usage parameter to the session.

2. The method of claim 1 wherein the step of backing up the at least one first entity comprises the steps of:
copying the at least one first entity from a second storage device associated with the computing platform; and
determining the at least one second entity associated with the at least one aspect from the at least one first entity.

3. The method of claim 1 wherein the at least one aspect relates to a device of the host computing platform.

4. The method of claim 1 wherein the at least one first entity or the at least one second entity is an at least one device driver.

5. The method of claim 1 wherein the at least one first entity or the at least one second entity is an at least one item related to communication configuration.

6. The method of claim 1 wherein the at least one second entity is the at least one first entity.

7. The method of claim 1 further comprising the step of updating the storage device with an at least one configuration parameter associated with the at least one second entity.

8. The method of claim 7 wherein the at least one configuration parameter is an at least one registry entry.

9. The method of claim 1 further comprising the step of copying the at least one first entity from the location to the storage device.

10. The method of claim further comprising the step of receiving the at least one second entity.

11. The method of claim 10 wherein the at least one second entity is downloaded from a web site.

12. The method of claim 1 wherein the location is a location on the storage device.

13. The method of claim 2 wherein determining the at least one second entity relates to an at least one registry entry.

14. The method of claim 1 further comprising the step of modifying an at least one configuration parameter on the storage device.

15. The method of claim 1 wherein the storage device is a flash memory device.

16. The method of claim 1 wherein the storage device is a phone.

17. The method of claim 1 wherein the at least one usage parameter is selected from the group consisting of: an operating system; a registry entry; a graphic user interface parameter; a web site list; and a desktop description.

18. The method of claim 1 further comprising the steps of:
copying an at least one content item from an at least one source computing platform to the storage device;
copying an application for booting a computing platform from an external device to the storage device; and
copying a backup application to the storage device.

19. The method of claim 18 wherein the at least on content item is selected from the group consisting of: an operating system; a registry entry; a graphic user interface parameter; a web site list; a desktop description; an application; and a data file.

20. The method of claim 1 further comprising the step of disabling a user using the host computing platform from accessing an at least one storage device associated with the computing platform.

21. The method of claim 1 further comprising the steps of:
determining whether the storage device was already connected to host computing platform; and
restoring the at least one second entity on the storage device.

22. A storage device for applying an at least one usage parameter to a session in which a user is using a host computing platform, the storage device storing:
an application for storing an at least one first entity associated with an at least one aspect of the host computing platform on the storage device; and
an application for booting the host computing platform from the storage device using an at least one second entity and applying the at least one usage parameter to the session.

23. The storage device of claim 22 further storing one or more items selected from the group consisting of: an operating system; an at least one usage parameter; a device driver; a registry entry; an application; and a data file.

24. The storage device of claim 22 wherein the application for storing the at least one first entity further comprises an application for determining the at least one second entity from the at least one first entity.

25. The storage device of claim 24 wherein the application for determining the at least one second entity relates to an at least one registry entry of the host computing platform.

26. The storage device of claim 22 wherein the at least one first entity or the at least one second entity is an at least one device driver of the host computing platform.

27. The storage device of claim 22 wherein the at least one first entity or the at least one second entity is an at least one item related to communication configuration.

28. The storage device of claim 22 further storing at least two entities, each of the at least two entities related to a different computing platform.

29. The storage device of claim 22 further comprising an application for receiving an at least one second entity associated with the at least one aspect of the host computing platform.

30. The storage device of claim 29 wherein receiving the at least one second entity is performed by downloading the at least one second entity.

31. The storage device of claim 28 wherein the at least one aspect of the at least one computing platform comprises an at least one registry entry.

32. The storage device of claim 22 further storing host computing platforms association data.

33. The storage device of claim 22 further storing an application for disabling a user using the host computing platform from accessing an at least one storage device associated with the computing platform.

34. The storage device of claim 22 wherein the storage device is a phone.

35. The storage device of claim 22 wherein the storage device is a flash memory device.
